(19) United States
(12) Patent Application Publication
(10) Pub. No.: US 2023/0309733 A1
(43) Pub. Date: Oct. 5, 2023

(54) FOOD STEAMER SYSTEMS

(71) Applicant: Sensio Inc., New York, NY (US)

(72) Inventors: Jorge B. Garcia, Rogers, AR (US); Tristan Mckeever, Montreal (CA)

(21) Appl. No.: 18/131,274

(22) Filed: Apr. 5, 2023

Related U.S. Application Data
(60) Provisional application No. 63/327,679, filed on Apr. 5, 2022.

(51) Int. Cl. A47J 27/04

(52) U.S. Cl. CPC A47J 27/04; A47J 2027/043

(57) ABSTRACT

In accordance with at least one aspect of this disclosure, a food steaming system includes an enclosed interior space defined by a first wall and a cooking volume within the interior space defined by a second wall radially inboard of the first wall forming an annulus between the first wall and the second wall. A steam generator is disposed proximate the cooking volume configured to inject a steam flow into the annulus prior to the steam flow entering the cooking volume. An air mover is operatively connected to move the steam flow upwards through the annulus from a lower portion of the interior space to an upper portion of the interior space, the air mover positioned downstream from the steam generator.

### CROSS-REFERENCE TO RELATED APPLICATIONS

This application claims priority to and the benefit of U.S. Provisional Patent Application No. 63/327,679, filed Apr. 5, 2022, the entire content of which is incorporated herein by reference.

### TECHNICAL FIELD

The present disclosure relates to food steamers.

### BACKGROUND

Current food steamer technology often implements steam cooking into existing cooking products, such as ovens or air fryers, meaning the cooking unit must heat up first, before steam can be generated. However, this increases the overall cooking time and does not allow for steam to be generated at any time that the system is on. Further, current cooking appliances that offer steamer functionality do not permit water reservoirs to be added mid cycle, or allow for varying tank sizes to be used with the system. This means a user has less control over how the cooking appliance can handle the foodstuffs within the appliance, and can lead to less efficient and slower overall cooking, as well as, in some cases, incomplete or inconsistent cooking.

The conventional techniques for steam cooking foodstuffs have been considered satisfactory for their intended purpose. However, there is an ever present need for improved systems and methods for steaming foodstuffs to achieve more consistent results. This disclosure provides a solution for this need.

### SUMMARY

In accordance with at least one aspect of this disclosure, a food steaming system includes an enclosed interior space defined by a first wall and a cooking volume within the interior space defined by a second wall radially inboard of the first wall forming an annulus between the first wall and the second wall. A steam generator is disposed proximate the cooking volume configured to inject a steam flow into the annulus prior to the steam flow entering the cooking volume. An air mover is operatively connected to move the steam flow upwards through the annulus from a lower portion of the interior space to an upper portion of the interior space, the air mover positioned downstream from the steam generator.

In embodiments, the air mover can be configured to form an upward moving cyclonic steam flow within the annulus rotating about a rotational axis of the air mover. In certain embodiments, the air mover can include a fan operatively connected to a motor via a drive shaft to drive the air mover.

In embodiments, the steam generator includes a water inlet, a heating element, and a steam outlet, the water inlet and heating element being upstream of the steam outlet. In embodiments a steam guide can be disposed between the steam generator and the lower portion of the interior space configured to guide the steam from the steam generator to the lower portion of the interior space. In certain embodiments, the steam guide can include a conduit having an inlet and an outlet. The inlet of the steam guide conduit can be outside of the interior space and the outlet of the steam guide conduit can be within the interior space and can be adjacent to the air mover. An outlet of the steam generator can be disposed within the inlet of the steam guide conduit.

A reservoir can be fluidly connected to the water inlet to provide water to the steam generator via the water inlet. In certain embodiments, the reservoir can be removeably coupled to the food steamer system. In certain embodiments, the reservoir can be expandable to accommodate varying volumes, for example based on an amount of foodstuffs within the cooking volume. A pump can be fluidly connected to pump water from the reservoir to the steam generator via the water inlet.

In embodiments, a deflector plate can be disposed at the upper portion of the interior space and extending into the cooking volume configured to deflect steam flow from the annulus into the cooking volume as a downward moving cyclonic steam flow. In certain embodiments, the deflector plate can have a generally conical shape, and a peak of the deflector plate can extend downwards into the cooking volume. In certain embodiments, the cooking volume can include an upper cooking volume and a lower cooking volume. In certain such embodiments, the second wall can include a gap between the upper cooking volume and the lower cooking volume to allow the steam flow moving in the annulus to enter the lower cooking volume, while the steam flow continues in the annulus to the upper cooking volume, e.g., before being deflected into the upper cooking volume by the deflector plate.

In certain embodiments, the deflector plate can be a first deflector plate, and the food steamer system can include a second deflector plate disposed at an upper portion of the lower cooking volume. In embodiments, the first deflector plate can be defined on an interior surface of a lid of the food steamer system, the lid configured to seal the interior space relative to an ambient atmosphere. The second deflector plate can be defined on a bottom surface of a tray for holding foodstuffs in the upper cooking volume. In certain embodiments, the food steamer system can include a plurality of trays for dividing the cooking volume, and each tray can define a deflector plate on a bottom surface.

A controller can be operatively connected to the motor coupled to the air mover to drive the air mover at one or more predetermined speeds based on input received from a user. In embodiments, the one or more predetermined speeds can include a first speed configured and adapted to provide an optimal steam flow to a single cooking volume within the interior space and a second speed configured and adapted to provide an optimal steam flow to multiple cooking volumes within the interior space. In embodiments, the user input can include a number of cooking volumes occupied with foodstuffs. The user input can be provided to the controller through user selection on a user interface. In certain embodiments, the user interface can include a button (or one or more buttons) operatively connected to the controller. An electrical connection means configured to provide electrical power from an external power source to the one or more electrical components of the food steamer system can also be included.

In embodiments, a drip tray can be operatively connected to the lower portion of the cooking volume configured to catch condensate formed in the cooking volume to prevent condensate from interacting with the air mover. In embodiments, the drip tray can be sealed to the lower portion of the cooking volume to prevent condensate from interacting with the air mover. An electronics compartment configured to house one or more electronics components of the food steamer system can be defined below the interior space, and the electronics compartment can be sealed relative to the interior space to prevent the steam flow or condensate from interacting with the one or more electronics components. In embodiments, a cooling fan can be disposed in a first wall of the electronics compartment configured to draw ambient air into the electronics compartment to cool the one or more electronics components, and an exhaust fan can be disposed in the a second wall of the electronics compartment configured to exhaust air from the electronics compartment.

In accordance with at least one aspect of this disclosure, a food steamer can include a steamer unit configured to cook foodstuffs within the steamer unit using a steam flow and a base unit operatively coupled to the steamer unit configured to provide the steam flow to the steamer unit. In embodiments, the base unit can include a steam generator configured to generate the steam flow, and an air mover disposed below the steamer unit configured to drive the steam flow from the steam generator upwards into the steamer unit as an upward moving cyclonic column of steam rotating about a rotational axis of the air mover and along an outer periphery of the steamer unit.

In embodiments, the steamer unit can include an enclosed interior space defined by a first wall and a cooking volume within the interior space defined by a second wall radially inboard of the first wall forming an annulus therebetween, where the cyclonic column of steam can be configured to rotate within the annulus. In embodiments, the steamer unit can also include a deflector plate disposed at an upper portion of the interior space and extending into the cooking volume, the deflector plate having a generally conical shape and wherein a peak of the deflector plate extends downwards into the cooking volume configured to deflect the upward moving cyclonic column of steam into the cooking volume downwards towards the foodstuffs within the steamer unit as a downward moving cyclonic flow of steam.

In embodiments, the base unit can further include an expandable fluid reservoir fluidly connected to provide water to the steam generator and a pump fluidly connected to pump water from the reservoir to the steam generator, the steam generator being configured to generate and inject steam into the steamer unit while the steamer unit is already in operation. In embodiments, an amount of steam injected into the steamer unit can be controlled as a function of a number of cooking volumes within the steamer unit. In embodiments, a speed of the air mover can be controlled as a function of a number of cooking volumes within the steamer unit. The base unit can include a user interface having one or more buttons thereon configured to provide user input to the controller.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective view of a system in accordance with this disclosure, showing a steamer unit and a base unit; and

FIG. 2 is a cross sectional perspective view of the system of FIG. 1, showing a portion of an interior of the steamer unit and the base unit.

### DETAILED DESCRIPTION

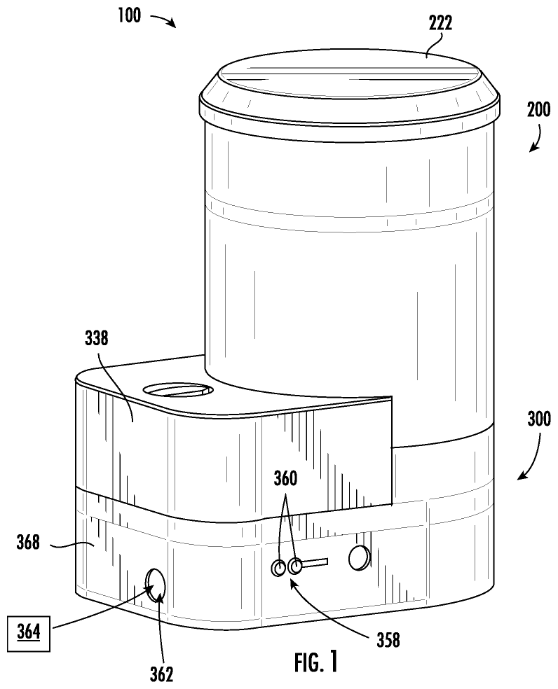

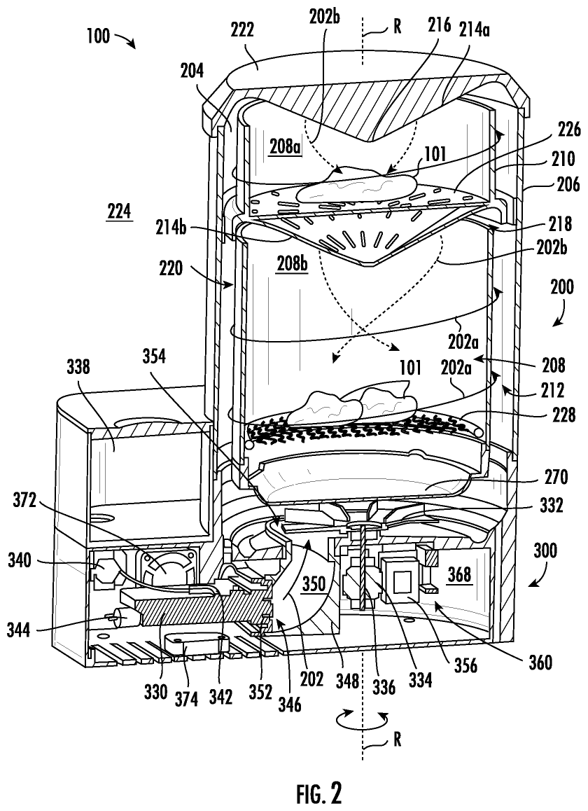

Reference will now be made to the drawings wherein like reference numerals identify similar structural features or aspects of the subject disclosure. For purposes of explanation and illustration, and not limitation, an illustrative view of an embodiment of a system (e.g., a food steamer) in accordance with the disclosure is shown in FIG. 1 and is designated generally by reference character 100. Other embodiments and/or aspects of this disclosure are shown in FIG. 2.

As shown in FIGS. 1 and 2, in accordance with at least one aspect of this disclosure, a food steamer 100 can include a steamer unit 200 configured to cook foodstuffs 101 within the steamer unit 200 using a steam flow 202, and a base unit 300 operatively coupled to the steamer unit 200 configured to provide the steam flow 202 to the steamer unit 200.

As shown in FIG. 2, the steamer unit 200 can include an enclosed interior space 204 defined by a first wall 206 and a cooking volume 208 within the interior space 204 defined by a second wall 210 radially inboard of the first wall 206, forming an annulus 212 therebetween. The steam flow 202 provided from the base unit 300 can be produced as an upwards moving cyclonic column of steam 202a can be configured to rotate within the annulus 212, e.g., about the cooking volume 208. In embodiments, the steamer unit 200 can also include a deflector plate 214 disposed at an upper portion 204a of the interior space 204 and extending into the cooking volume 208, the deflector plate 214 having a generally conical shape, a peak 216 of the deflector plate 214 extending downwards into the cooking volume 208. The downwards facing conical shape of the deflector plate 214 can be configured to deflect the upward moving cyclonic column of steam 202a into the cooking volume 208 downwards towards the foodstuffs 101 within the steamer unit 200 as a downward moving cyclonic flow of steam 202b, forcing the steam 202b through the foodstuffs 101.

In certain embodiments, e.g., as shown in FIG. 2, the cooking volume 208 can include an upper cooking volume 208a and a lower cooking volume 208b. In certain such embodiments, the second wall 210 can include a gap 218 between the upper cooking volume 208a and the lower cooking volume 208b to allow a portion of the steam flow 202a moving in the annulus 212 to enter the lower cooking volume 208b, while a portion of the steam flow 202a continues in the annulus 212 to the upper cooking volume 208a, before being deflected into the upper cooking volume 208 by the deflector plate 214.

In certain embodiments, the deflector plate can be a first deflector plate 214a, and the food steamer system 100 can include a second deflector plate 214b disposed at an upper portion 220 of the lower cooking volume 208b. In embodiments, the first deflector plate 214a can be defined on an interior surface of a lid 222 of the food steamer 100, the lid 222 configured to seal the interior space 204 relative to an ambient atmosphere 224. The second deflector plate 214b can be defined on a bottom surface of a tray 226 for holding foodstuffs 101 in the upper cooking volume 208a. In certain embodiments, the food steamer system 100 can include a plurality of trays 226 for dividing the cooking volume 208, and each tray 226 can define a deflector plate on a respective bottom surface. Certain trays can be included in the food steamer 100 but may not define any deflector plate, for example, as shown in FIG. 2, tray 228, which is configured as a wire rack. Any suitable tray can be used, for example, the tray 226 as shown in the upper cooking volume 208a can be a flat tray with ventilation holes defined therein.

Still with reference to FIG. 2, the base unit 300 includes a steam generator 330 disposed proximate the interior space 204 configured to inject the steam flow 202 into the annulus 212 prior to the steam flow 202 entering the cooking volume 208. The steam generator 330 can be configured to generate and inject steam into the steamer unit 200 while the steamer unit 200 is already in operation, for example, the steam generator 330 can continuously or intermittently inject steam into the steamer unit 200. An air mover 332 can be operatively connected to move the steam flow 202 upwards through the annulus 212 from a lower portion of the interior space 204b to the upper portion of the interior space 204a. The air mover can include a fan (e.g., as shown) operatively connected to a motor 334 via a drive shaft 336 to drive the air mover 332 about a rotational axis R. As shown, the air mover 332 is positioned downstream from the steam generator 330 and below the steamer unit 200, e.g., below the interior space 204 and cooking volume 208 so that the steam flow 202 flows up through then annulus 212 and then down through the cooking volume 208 and through the foodstuffs 101 therein. In embodiments, the air mover 332 is configured to form the upward moving cyclonic steam flow 202a within the annulus 212 rotating about the rotational axis R, and along an outer periphery of the steamer unit 200, e.g., along at least the first wall 206.

In embodiments, the base unit 300 can also include a fluid reservoir 338 fluidly connected to provide water to the steam generator 330, and a pump 340 fluidly connected to pump water from the reservoir 338 to the steam generator 330. In certain embodiments, the reservoir 338 can be removeably coupled to the food steamer system 100. In certain embodiments, the reservoir 338 can be expandable to accommodate varying volumes of water, for example based on an amount of foodstuffs 101 within the steamer unit 200. The reservoir 338 can be configured to allow for water to be added to the reservoir 338 mid-cycle. The reservoir 338 can be fluidly connected to a water inlet 342 of the steam generator 330 to provide water to the steam generator 330 via the water inlet 342. The steam generator 330 also includes a heating element 344, and a steam outlet 346, the water inlet 342 and heating element 344 being upstream of the steam outlet 346.

With continued reference to FIG. 2, as shown, in certain embodiments a steam guide 348 can be disposed between the steam generator 330 and the lower portion of the interior space 204b configured to guide the steam 202 from the steam generator 330 to the lower portion of the interior space 204b and to the air mover 332. In certain embodiments, the steam guide 348 can include a conduit 3580 having an inlet 352 and an outlet 354. The inlet 352 of the steam guide conduit 350 can be outside of the interior space 204 and the outlet 354 of the steam guide conduit 350 can be within the interior space 204 and can be adjacent to the air mover 332. The steam outlet 346 of the steam generator 330 can be disposed within the inlet 352 of the steam guide conduit 350.

A controller 356 (e.g., a motor controller) can be operatively connected to the motor 334 to control the motor 334 to drive the air mover 332 at one or more predetermined speeds based on input received from a user, e.g., from a user interface 358 (shown in FIG. 1). In embodiments, the one or more predetermined speeds can include a first speed configured and adapted to provide an optimal steam flow to a single cooking volume (e.g., when only the lower volume 208b is utilized) and a second speed configured and adapted to provide an optimal steam flow to multiple cooking volumes (e.g., when both the upper and lower cooking volumes 208a,b are utilized, such as shown), where the second speed is faster than the first speed. In embodiments, the user input can include a number of cooking volumes 208 utilized, along with other parameters, such as type of foodstuffs, type of preparation, and the like. The base unit 300 can include the user interface 358 having one or more buttons 360 thereon, for example as shown in FIG. 1, configured to provide user input to the controller 358. In embodiments, an amount of steam 202 injected into the steamer unit 200 and/or the speed of the air mover 332 can be controlled as a function of an amount of foodstuffs within the steamer unit 200 or the number of cooking volumes utilized (e.g., as provided to the controller 358 through user selection on the user interface 358).

An electronics compartment 368 configured to house one or more electronics components of the food steamer system 100 can be defined in the base unit 300 below the interior space 204. The base unit 300 can also include an electrical connection means 362 configured to provide electrical power from an external power source 364 to the one or more electrical components 366 of the food steamer system 100, the electrical connection means 362 housed at least partially within the electronics compartment 368.

In embodiments, the steamer unit 200 can include a drip tray 270 can be operatively connected to the lower portion of the cooking volume 208 configured to catch condensate formed in the cooking volume 208 to prevent the condensate from interacting with the air mover 332 and the electrical components 366 in the electronics compartment 368. The electronics compartment 368 can further be sealed relative to the interior space 204 to prevent the steam flow 202 or condensate from interacting with the one or more electronics components 366. In embodiments, a cooling fan 372 can be disposed in a first wall of the electronics compartment 368 configured to draw ambient air into the electronics compartment 368 to cool the one or more electronics components 366. An exhaust fan 374 can be disposed in the a second wall of the electronics compartment 366 configured to exhaust warm air from the electronics compartment 366.

Embodiments of the food steamer system 100 allow for faster heat-up times, provide relatively instantaneous steam generation (e.g., within a few seconds, rather than minutes), provide more effective and efficient cooking through the cyclonic airflow, and allow for more control over the cooking cycle by adapting the reservoir and cooking volume based on the number of cooking volumes utilized. Embodiments can allow for the steamer unit to be adjustable, for example, if only one cooking volume is needed or desired, the lid can be configured to interface directly with the lower cooking volume, e.g., at the gap, where the upper cooking volume is removed from the system entirely.

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “controller.” A “circuit,” “module,” or “controller” can include one or more portions of one or more separate physical hardware and/or software components that can together perform the disclosed function of the “circuit,” “module,” or “controller”, or a “circuit,” “module,” or “controller” can be a single self-contained unit (e.g., of hardware and/or software). Furthermore, aspects of this disclosure may take the form of a computer program product embodied in one or more computer readable medium(s) having computer readable program code embodied thereon.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the apparatus and methods of the subject disclosure have been shown and described, those skilled in the art will readily appreciate that changes and/or modifications may be made thereto without departing from the scope of the subject disclosure.

What is claimed is:

1. A food steaming system, comprising:
an enclosed interior space defined by a first wall;
a cooking volume within the interior space defined by a second wall radially inboard of the first wall forming an annulus between the first wall and the second wall;
a steam generator disposed proximate the cooking volume configured to inject a steam flow into the annulus prior to the steam flow entering the cooking volume; and
an air mover operatively connected to move the steam flow upwards through the annulus from a lower portion of the interior space to an upper portion of the interior space.

2. The food steaming system of claim 1, wherein the air mover is configured to form an upward moving cyclonic steam flow within the annulus rotating about a rotational axis of the air mover.

3. The food steaming system of claim 1, wherein the steam generator includes a water inlet, a heating element, and a steam outlet, the water inlet and heating element being upstream of the steam outlet.

4. The food steaming system of claim 3, further comprising a reservoir fluidly connected to the water inlet to provide water to the steam generator via the water inlet.

5. The food steaming system of claim 4, further comprising a pump fluidly connected to pump water from the reservoir to the steam generator via the water inlet.

6. The food steaming system of claim 1, further comprising a deflector plate disposed at the upper portion of the interior space and extending into the cooking volume configured to deflect steam flow from the annulus into the cooking volume as a downward moving cyclonic steam flow.

7. The food steaming system of claim 6, wherein the deflector plate has a generally conical shape, wherein a peak of the deflector plate extends downwards into the cooking volume.

8. The food steaming system of claim 1, wherein the cooking volume includes an upper cooking volume and a lower cooking volume, wherein the second wall includes a gap between the upper cooking volume and the lower cooking volume to allow the steam flow moving in the annulus to enter the lower cooking volume, while the steam flow continues in the annulus to the upper cooking volume.

9. The food steaming system of claim 8, wherein the deflector plate is a first deflector plate, and further comprising a second deflector plate disposed at an upper portion of the lower cooking volume.

10. The food steaming system of claim 9, wherein the first deflector plate is defined on an interior surface of a lid of the food steamer system, wherein the second deflector plate is defined on a bottom surface of a tray for holding foodstuffs in the upper cooking volume.

11. The food steaming system of claim 1, further comprising a controller operatively connected to a motor coupled to the air mover to drive the air mover at one or more predetermined speeds based on input received from a user.

12. The food steaming system of claim 11, wherein the one or more predetermined speeds includes a first speed configured and adapted to provide an optimal steam flow to a single cooking volume within the interior space and a second speed configured and adapted to provide an optimal steam flow to multiple cooking volumes within the interior space.

13. The food steaming system of claim 12, wherein the user input includes a number of cooking volumes occupied with foodstuffs selected by the user on a user interface operatively connected to provide the user input to the controller.

14. The food steaming system of claim 1, further comprising a drip tray operatively connected to the lower portion of the cooking volume configured to catch condensate formed in the cooking volume to prevent condensate from interacting with the air mover.

15. A food steamer, comprising:
a steamer unit configured to cook foodstuffs within the steamer unit using a steam flow;
and a base unit operatively coupled to the steamer unit configured to provide the steam flow to the steamer unit, the base unit comprising:
a steam generator configured to generate the steam flow; and
an air mover disposed below the steamer unit configured to drive the steam flow from the steam generator upwards into the steamer unit as an upward moving cyclonic column of steam rotating about a rotational axis of the air mover and along an outer periphery of the steamer unit.

16. The food steamer of claim 15, wherein the steamer unit further includes:
an enclosed interior space defined by a first wall;
a cooking volume within the interior space defined by a second wall radially inboard of the first wall forming an annulus therebetween, wherein the cyclonic column of steam is configured to rotate within the annulus.

17. The food steamer of claim 16, wherein the steamer unit further includes a deflector plate disposed at an upper portion of the interior space and extending into the cooking volume, the deflector plate having a generally conical shape and wherein a peak of the deflector plate extends downwards into the cooking volume configured to deflect the upward moving cyclonic column of steam into the cooking volume downwards towards the foodstuffs within the steamer unit as a downward moving cyclonic flow of steam.

18. The food steamer of claim 15, wherein the base unit further includes an expandable fluid reservoir fluidly connected to provide water to the steam generator and a pump fluidly connected to pump water from the reservoir to the steam generator.

19. The food steamer of claim 15, wherein an amount of steam injected into the steamer unit is controlled as a function of a number of cooking volumes within the steamer unit.

20. The food steamer of claim 15, wherein a speed of the air mover is controlled as a function of a number of cooking volumes within the steamer unit.
